(19) United States
(12) Patent Application Publication
(10) Pub. No.: US 2019/0193651 A1
(43) Pub. Date: Jun. 27, 2019

(54) COVERING DEVICE FOR A MOTOR VEHICLE

(71) Applicant: Juergen SALEWSKI, Rochester Hills, MI (US)

(72) Inventor: Juergen SALEWSKI, Rochester Hills, MI (US)

(21) Appl. No.: 16/212,048

(22) Filed: Dec. 6, 2018

Related U.S. Application Data
(60) Provisional application No. 62/608,985, filed on Dec. 21, 2017.

(51) Int. Cl. B60R 13/02; B60N 3/10

(52) U.S. Cl. CPC B60R 13/02; B60N 3/10

(57) ABSTRACT

Covering device for a motor vehicle having a foldable flat structure including a plurality of flat elements connected together in an articulated manner and displaceably guided on at least one guide device between a covered position in which the flat structure at least partially covers a receiver space and an uncovered position in which the flat structure at least partially uncovers the receiver space. The at least one guide device includes at least one control region, with different guide elements of the flat elements being path-controlled differently thereon, such that in the uncovered position the flat elements are pivoted at an angle to one another and the flat structure is folded in the manner of a concertina. A flexible covering structure is provided, the flexible covering structure at least partially spanning the flat elements and forming a visible surface of the foldable flat structure.

### CROSS-REFERENCE TO RELATED APPLICATIONS

This claims priority from U.S. Provisional Application No. 62/608,985, filed Dec. 21, 2017, the disclosure of which is hereby incorporated by reference in its entirety into this application.

### RELATED FIELD

The invention relates to a covering device for a motor vehicle having at least one foldable flat structure which comprises a plurality of substantially dimensionally stable flat elements which are connected together in an articulated manner and which are displaceably guided on at least one guide device between a covered position in which the flat structure at least partially covers a receiver space and an uncovered position in which the flat structure at least partially uncovers the receiver space, wherein the at least one guide device comprises at least one control region, different guide elements of the flat elements being path-controlled differently thereon, such that in the uncovered position the flat elements are pivoted at an angle to one another and the flat structure is folded in the manner of a concertina.

### BACKGROUND

Such a covering device is disclosed in EP 0 960 778 A2. The known covering device is provided, in particular, for covering a receiver space for objects arranged on the vehicle side between the front seats of the motor vehicle, for example a mobile telephone, a set of keys, or the like. The known covering device comprises a foldable flat structure which is formed from a plurality of flat elements which are connected together in an articulated manner. The flat elements in each case are guided in a displaceable manner by means of differently designed guide elements in a guide device between a covered position and an uncovered position. The guide device comprises a control region. This control region is designed such that the different guide elements are path-controlled in different ways when displaced from the covered position into the uncovered position, so that in the uncovered position the flat elements are arranged in an approximately zig-zag manner relative to one another.

### SUMMARY

It is the object of the invention to provide a covering device of the type mentioned in the introduction which has improved properties relative to the prior art.

This object is achieved by a flexible covering structure being provided, said flexible covering structure at least partially spanning the flat elements and forming a visible surface of the foldable flat structure. The flexible covering structure serves in this regard at least for the visible covering of the flat elements. By the solution according to the invention, therefore, the impression of quality of the covering device is improved. This is because the flexible covering structure forms a visible surface which covers gap regions arranged between the flat elements. Additionally, by means of the solution according to the invention it is possible to prevent a penetration of dirt particles, dust or the like into the gap regions between the flat elements and an impairment of the articulated pivotability of the flat elements associated therewith. This is because such dirt particles or dust are held back by the flexible covering structure. Preferably, the flexible covering structure is designed to be flexurally flexible. Additionally, the flexible covering structure may be designed to be longitudinally and/or transversely flexible and in this regard expandable in its longitudinal and/or transverse direction. The flexible covering structure may be configured, for example, in the form of a material web produced from plastics material and/or a textile material web. Preferably, the flexible covering structure is designed to be thin-walled compared to the flat elements so that by means of the covering structure preferably a type of coating and/or a type of covering of the flat elements is formed. The flexible covering structure may be connected by a non-positive, positive and/or material connection to the flat elements. Preferably, the flexible covering structure and the flat elements are bonded together and/or injection-molded onto one another by means of plastics injection-molding. The flexible covering structure may be connected, for example, in a two-dimensional, linear and/or punctiform manner to the flat elements. Within the meaning of this invention, the visible surface is to be understood as a surface of the covering device which, when the covering device is assembled as intended on and/or in the motor vehicle, is able to be easily seen by a person, at least in the covered position of the flat structure.

The solution according to the invention is suitable in a particularly advantageous manner for use in a passenger motor vehicle. For example, the solution according to the invention in the form of a cover for a glove compartment, central console or cup holder is suitable for use in the interior of the passenger motor vehicle. Notwithstanding this, however, the solution according to the invention may also be used in the external region of a motor vehicle, for example in the case of a covering device in the form of a load area cover of a utility vehicle. In this regard, the solution according to the invention is limited neither to a use in a passenger motor vehicle nor to a use in a vehicle interior.

In an embodiment of the invention, in the covered position the flexible covering structure is substantially smooth-surfaced and in the uncovered position the flexible covering structure is folded together with the flat structure in the manner of a concertina. By this embodiment of the invention, firstly in the covered position an attractive appearance and thus an improved impression of quality are achieved and secondly in the uncovered position a particularly space-saving arrangement of the flexible covering structure is possible. In the covered position, the flexible covering structure may be arranged, for example, to be substantially planar with a smooth surface or curved with a smooth surface. Preferably, in the covered position the flexible covering structure is tensioned as a smooth surface.

In a further embodiment of the invention, the flexible covering structure forms in each case an articulated connection in the manner of a film hinge between adjacently arranged flat elements. In this embodiment of the invention, the flexible covering structure in this regard additionally serves as an articulated connection between the flat elements. As a result, mechanical articulated elements for connecting the flat elements may be dispensed with and a particularly simple construction of the covering device may be achieved. The flat elements are preferably arranged one behind the other and adjacent to one another in a direction of displacement. In this case, the flat elements may be arranged closely adjacent, forming merely a contact gap and/or spaced apart and adjacent to one another, forming a spacer gap. The articulated connection comprises an articulation axis which preferably extends parallel to a longitudinal extent of such a contact gap and/or spacer gap.

In a further embodiment of the invention, flat elements which are arranged immediately adjacent to one another in each case form a flat element pair, wherein adjacent flat element pairs are arranged so as to form a fold gap. In any case, adjacent flat element pairs are preferably connected together in an articulated manner by means of the flexible covering structure. Alternatively or additionally, the flat elements of a flat element pair may be connected together in an articulated manner by means of the flexible covering structure. Alternatively or additionally, the flat elements of a flat element pair may be connected together by means of at least one mechanical articulated element, for example a hinge or the like. The fold gap formed between adjacent flat element pairs—relative to a direction of displacement of the flat structure—is preferably wider than a contact gap formed between the flat elements of individual flat element pairs. It has been shown that, as a result, in the uncovered position the flat elements may be angled relative to one another in an improved manner and the flat structure may be folded in the manner of a concertina in a particularly space-saving manner.

In a further embodiment of the invention, the flexible covering structure forms an articulated connection of a first type between the flat elements of a flat element pair and/or forms an articulated connection of a second type between adjacent flat element pairs in the region of the fold gap. The articulated connections of the first type and second type are preferably different from one another such that the articulated connection of the second type permits a greater pivotability relative to the size of angle than the articulated connection of the first type or vice-versa. Preferably, the fold gap between adjacent flat element pairs is dimensioned such that the articulated connection of the second type permits a pivoting of the flat element pairs by approximately 180° to one another. As a result, the flat structures in the region of adjacent flat element pairs may be folded substantially flat onto one another. This is a particularly space-saving embodiment of the invention.

The object underlying the invention is also achieved by the guide device comprising a main guide groove which extends longitudinally in a main direction and which in the control region branches into a first fold guide groove to which first guide elements are assigned, and into a second fold guide groove to which second guide elements are assigned, wherein the fold guide grooves extend longitudinally in a folding direction which is angled relative to the main direction.

By the angled orientation of the folding direction relative to the main direction, the solution according to the invention permits a particularly space-saving arrangement of the flat structure in the uncovered position and thus an improved uncovering of the receiving space. This is because in this manner the foldable flat structure is able to be angled during a displacement from the covered position into the uncovered position, for example—relative to the receiver space—downwardly along a side wall or at one side. As a result, it is possible to uncover the receiver space as fully as possible, for example at the top or to the side. Additionally, the solution according to the invention permits an improved guidance of the flat elements, since in the control region it is not just the individual guide elements which come out of engagement with the main guide groove in order to permit the folding in the manner of a concertina. This is because a first fold guide groove, to which first guide elements are assigned, and a second fold guide groove, to which second guide elements are assigned, are provided instead. As a result, in particular in the control region and during a displacement of the flat structure passing beyond the control region into the uncovered position, a forced guidance and thus improved path guidance of the guide elements is possible. As a result, it is possible to counteract jamming of the foldable flat structure on the guide device. The fold guide grooves preferably extend parallel to one another in the folding direction.

In a further embodiment of the invention, the main direction and the folding direction are angled relative to one another by more than 45°, preferably by approximately 90°. In particular, with an approximately right-angled arrangement of the main guide groove relative to the fold guide grooves, a further space-saving embodiment of the covering device may be achieved. This is because, in such an embodiment, when displaced into the uncovered position the flat elements are guided at right-angles from the main guide groove in the control region, for example downwardly or to one side of the receiver space. In this case, in the uncovered position the flat elements are uniformly stacked on top of one another instead of being merely folded up adjacent to one another in the main direction. By means of this embodiment, a covering device which is particularly compact in terms of structure is achieved.

In a further embodiment of the invention, the guide device comprises an angled, preferably L-shaped and/or U-shaped, guide frame, the main guide groove and the first fold guide groove and the second fold guide groove being incorporated therein. The guide frame is preferably angled in the control region. Accordingly, preferably a first limb of the guide frame has the main guide groove and a second limb of the guide frame has the two fold guide grooves. By means of this embodiment of the invention, the production and/or assembly may be carried out in a particularly simple manner.

The object underlying the invention is also achieved by two guide devices which are arranged opposite one another being provided, the flat elements in each case being displaceably guided thereon by means of first guide elements and second guide elements, wherein the guide elements and the control regions are arranged and/or designed asymmetrically—relative to a central longitudinal plane—such that similar guide elements of a flat element are path-controlled differently at the control regions. By the solution according to the invention, in particular, an improved guidance of the flat elements and thus an improved displaceability of the flat structure may be achieved between the covered and the uncovered position. This is because it has been shown that by the asymmetrical design of the control regions according to the invention and the asymmetrical arrangement of the guide elements, in particular, it is possible to counteract the guide elements becoming caught on the guide device. Additionally, by means of the solution according to the invention it is possible to counteract undesirable rattling of the guide elements during the displacement thereof along the guide device. The control regions in each case may comprise at least one control element in the manner of a diverter, in the form of a ramp, an indentation or the like. In this case, the control regions may be designed asymmetrically to one another such that, for example, a first guide element is path-controlled on a first of the control regions in a first direction, first groove and/or first guide path and a further first guide element is path-controlled on a second of the control regions in a second direction, second groove and/or second guide path. Alternatively or additionally, the opposing control regions of the guide devices may be designed asymmetrically to one another such that similar guide elements of one and the same flat element during a displacement of the flat structure between the covered position and the uncovered position are path-controlled at different times. Preferably, with the exception of the control regions the opposing guide devices are designed to be symmetrical relative to one another. Preferably, the guide devices are arranged on opposing side wall regions of the receiver space. The guide devices preferably oppose one another in the transverse direction of the flat structure.

In a further embodiment of the invention, the guide devices in each case comprise a main guide groove which in the region of the respective control region branches into a first fold guide groove, to which the first guide elements are assigned, and into a second fold guide groove, to which the second guide elements are assigned. The first fold guide groove of a first of the guide devices is preferably designed asymmetrically relative to the first fold guide groove of a second of the guide devices. Preferably, the same applies to the second fold guide grooves. Preferably, the first guide elements and the second guide elements are arranged in each case in the main guide grooves, provided the foldable flat structure is in the covered position. If the foldable flat structure is in the uncovered position, the first guide elements of a guide element are arranged in the first fold guide grooves and the second guide elements of the same flat element are arranged in the second fold guide grooves.

In a further embodiment of the invention, an axial length of the first guide elements is greater than an axial length of the second guide elements and/or a groove depth of the first fold guide grooves is greater than a groove depth of the second fold guide grooves. In this embodiment of the invention, in simplified terms the path control of the different guide elements is achieved by the main guide groove branching into fold guide grooves of different groove depth, wherein the relatively longer guide elements may be conducted into the relatively deeper fold guide grooves and the relatively shorter guide elements may be conducted into the relatively less deep fold guide grooves. This is an embodiment of the invention which is able to be implemented in a particularly simple structural manner.

In a further embodiment of the invention, in a first of the guide devices the main guide groove initially branches into the first fold guide groove and subsequently into the second fold guide groove, and in a second of the guide devices the main guide groove initially branches into the second fold guide groove and subsequently into the first fold guide groove. By this geometrically different design of the respective branching between the main guide groove and the fold guide grooves, an asymmetrical design of the control regions may be achieved in a simple manner.

In a further embodiment of the invention, the control region of a first of the guide devices comprises a first control element in the form of a ramp which adjoins a front end region of the main guide groove, the second guide elements being conducted thereby beyond the first fold guide groove. The ramp is preferably configured on a guide surface of the main guide groove. The guide surface is preferably a radial guide surface, the guide elements preferably being supported in a radially slidable manner when displaced along the guide device.

In a further embodiment of the invention, the control region of a second of the guide devices comprises a second control element in the form of an indentation which adjoins a front end region of the main guide groove, the second guide elements being conducted thereby to the second fold guide groove. The indentation is preferably configured on a guide surface of the main guide groove of the second guide device. In this case, the indentation forms a type of bearing surface which is shortened in the axial direction, the second guide elements being conducted thereon into the second fold guide groove. Since the first guide elements are axially longer than the second guide elements, and in this regard protrude in the axial direction over the indentation, these first guide elements are guided past the indentation and conducted to the first fold guide groove of the second guide device.

The invention further relates to an equipment unit, in particular a drinks holder, for a motor vehicle interior having at least one receiver space for receiving an object, in particular a drinks receptacle, and having a covering device which is assigned to the receiver space and which is designed according to one of the preceding claims. The equipment unit may be provided, for example, for assembly in the region of a central armrest in a rear region of the motor vehicle interior. Alternatively, the equipment unit may be provided for assembly between a driver's seat and a co-driver's seat of the motor vehicle interior.

In a further embodiment of the invention, two receiver spaces are provided, in each case a foldable flat structure being assigned thereto, wherein the receiver spaces and the foldable flat structures are arranged symmetrically such that the foldable flat structures are displaceable in opposing directions, in particular parallel to a transverse direction of the motor vehicle interior, between the covered position and the uncovered position. In this embodiment of the invention, the covering device accordingly has two opposingly actuatable flat structures. These flat structures are preferably guided on one and the same guide device. In particular, if the flat structures are displaceably arranged parallel to the transverse direction of the motor vehicle interior this results in an actuatability which is particularly advantageous in terms of ergonomics.

Further advantages and features of the invention are disclosed in the claims and in the following description of a preferred exemplary embodiment which is shown with reference to the drawings.

### BRIEF DESCRIPTION OF THE DRAWINGS

FIG. 1 shows in a schematic perspective view an embodiment of an equipment unit according to the invention in the form of a drinks holder arranged in a region of a central console arrangement, wherein the equipment unit comprises an embodiment of a covering device according to the invention,

FIG. 2 shows in an enlarged schematic perspective view the equipment unit according to FIG. 1, wherein the covering device adopts a covered position,

FIG. 3 shows in a view according to FIG. 2 the equipment unit according to FIGS. 1 and 2, wherein the covering device adopts an uncovered position,

FIGS. 4, 5 show the equipment unit according to FIGS. 1 to 3, omitting a housing upper shell, wherein the covering device adopts the covered position (FIG. 4) and/or the uncovered position (FIG. 5),

FIGS. 6, 7 show in each case in a schematic perspective view the covering device according to FIGS. 1 to 5, in the covered position (FIG. 6) and/or in the uncovered position (FIG. 7),

FIGS. 8, 9 show the covering device according to FIGS. 1 to 7, in the covered position in a first schematic perspective exploded view (FIG. 8) and in a further schematic perspective exploded view (FIG. 9),

FIG. 10 shows in a schematic perspective view, omitting a flexible covering structure, the covering device according to FIGS. 1 to 9 in the covered position,

FIG. 11 shows in a further schematic This perspective exploded view the covering device according to FIGS. 1 to 10 in the uncovered position,

FIG. 12 shows in a partially cut-away exploded view, omitting individual components, the covering device according to FIGS. 1 to 11 in the region of a foldable flat structure which is folded in the uncovered position in the manner of a concertina,

FIG. 13 shows the covering device This according to FIGS. 1 to 12 in the covered position, omitting the flexible covering structure, in a schematic view and

FIGS. 14, 15 show in each case in an enlarged perspective detailed view a region B (FIG. 14) and/or A (FIG. 15) in each case according to FIG. 13 of the covering device according to FIGS. 1 to 13.

### DETAILED DESCRIPTION

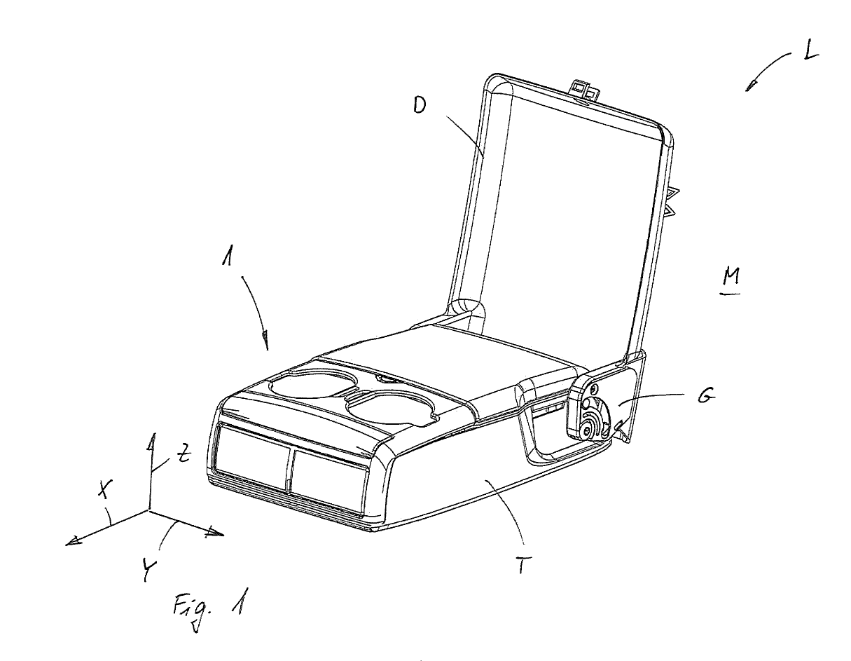

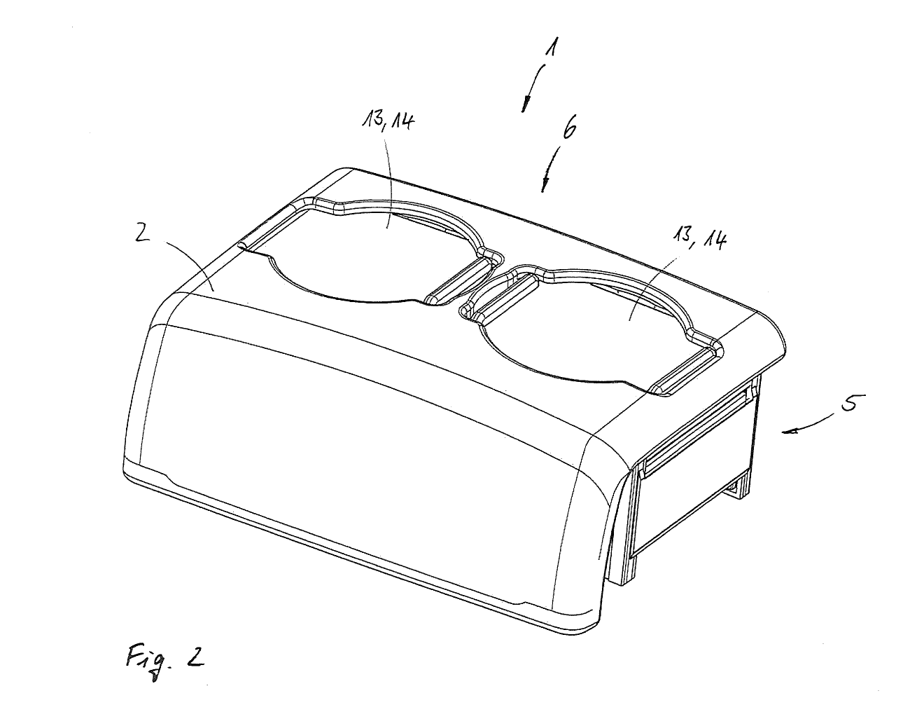

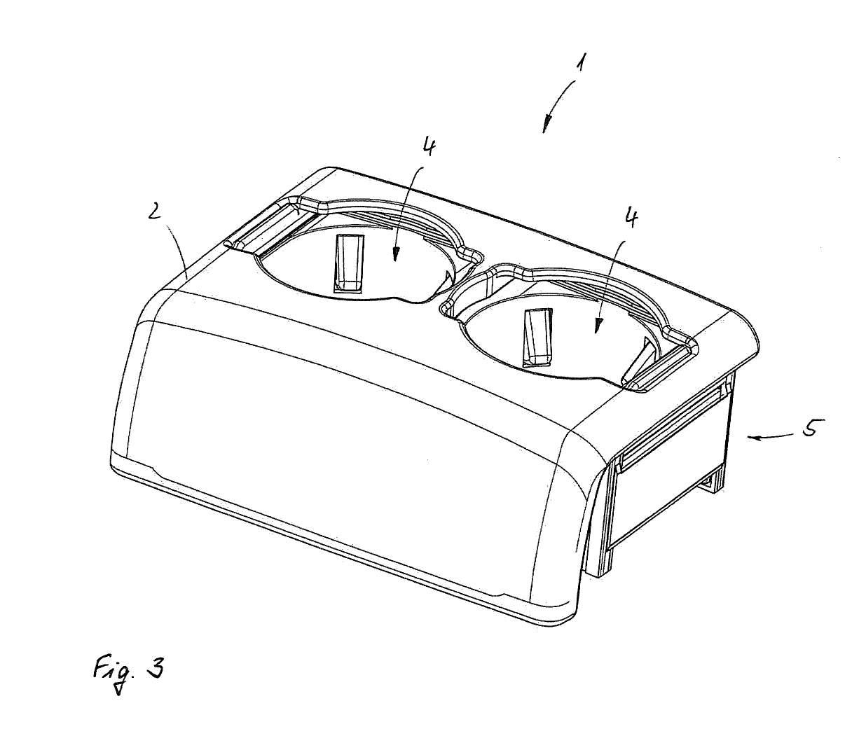

According to FIG. 1 a central console arrangement L which is provided for assembly in a region between two vehicle seats, not shown in more detail, of a motor vehicle interior M comprises a carrier unit T and a lid unit D which is pivotably supported on the carrier unit T by means of an articulated arrangement G in a manner known in principle. The lid unit D is pivotable between a closed position, not shown in more detail, in which the lid unit D substantially covers an upper face of the carrier unit T and an open position, which is able to be seen with reference to FIG. 1, in which the lid unit D protrudes substantially vertically and upwardly from the carrier unit T and uncovers the upper face thereof. In the present case, a longitudinal direction of the central console arrangement L is oriented parallel to a longitudinal direction X of the motor vehicle interior M. Relative to the longitudinal direction X, an equipment unit 1 is provided in a front region of the carrier unit T, which may be seen in detail in particular with reference to FIGS. 2 and 3.

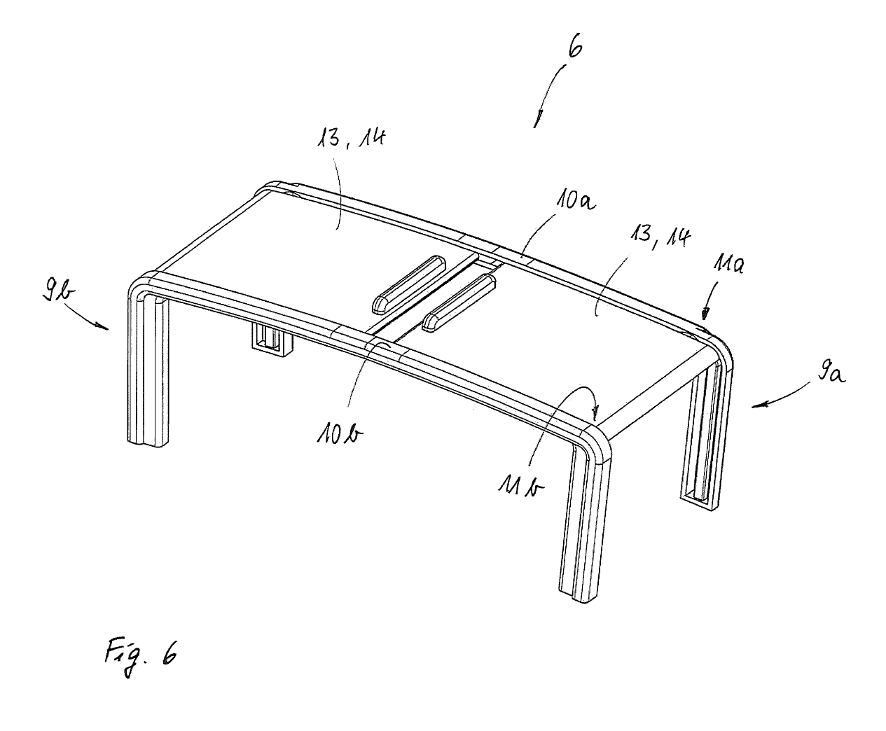

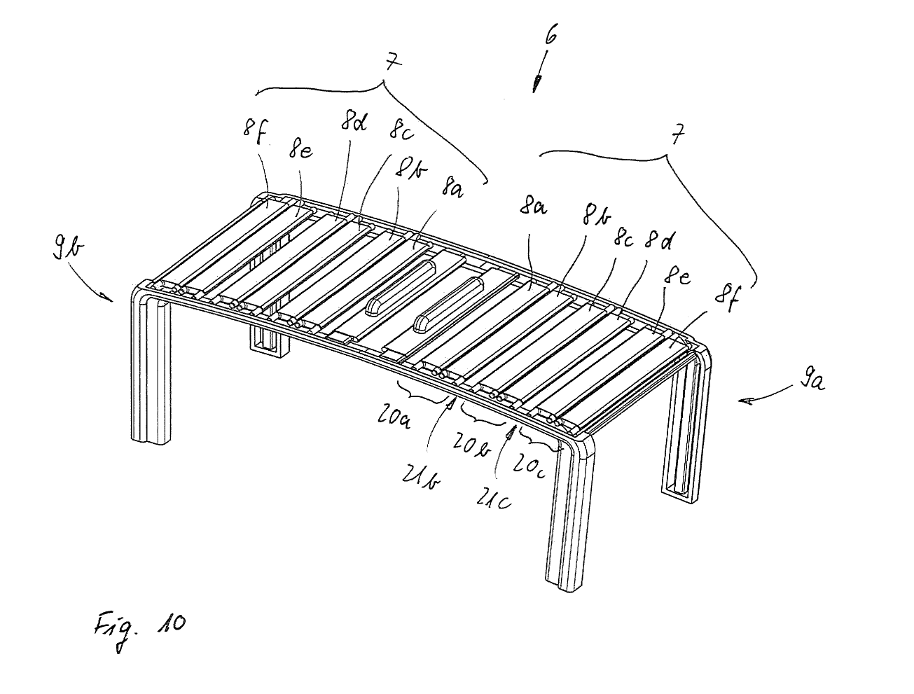

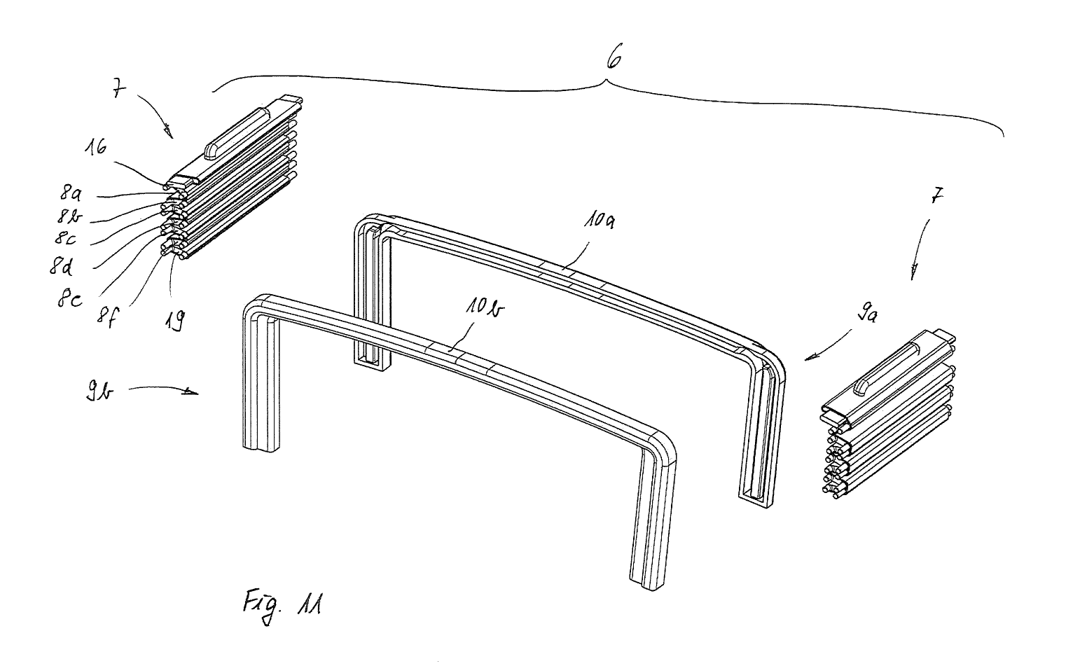

The equipment unit 1 comprises a housing upper shell 2 produced as a molded part and two receiver spaces 4 arranged adjacent to one another relative to a transverse direction Y of the motor vehicle interior M and formed by means of two cylindrical receivers 3, wherein both the housing upper shell 2 and the cylindrical receivers 3 are supported on a carrier frame 5 of the equipment unit 1 in a manner known in principle. This may be seen, in particular, with reference to FIGS. 3 to 5. The cylindrical receivers 3 and thus the receiver spaces 4 are in the present case respectively provided for at least partially receiving a drinks receptacle, such as for example a bottle, a cup or the like. In this regard, the equipment unit 1 in the present case is configured in the form of a drinks holder which may also be denoted as a cup holder, but which does not necessarily have to be the case. For example, instead of the two cylindrical receivers in the present case, just one receiver shell may be provided for receiving a mobile telephone or other objects. Moreover, the equipment unit 1 has a covering device 6, the details thereof in particular being able to be seen with reference to FIGS. 6 to 15 and being described hereinafter in detail.

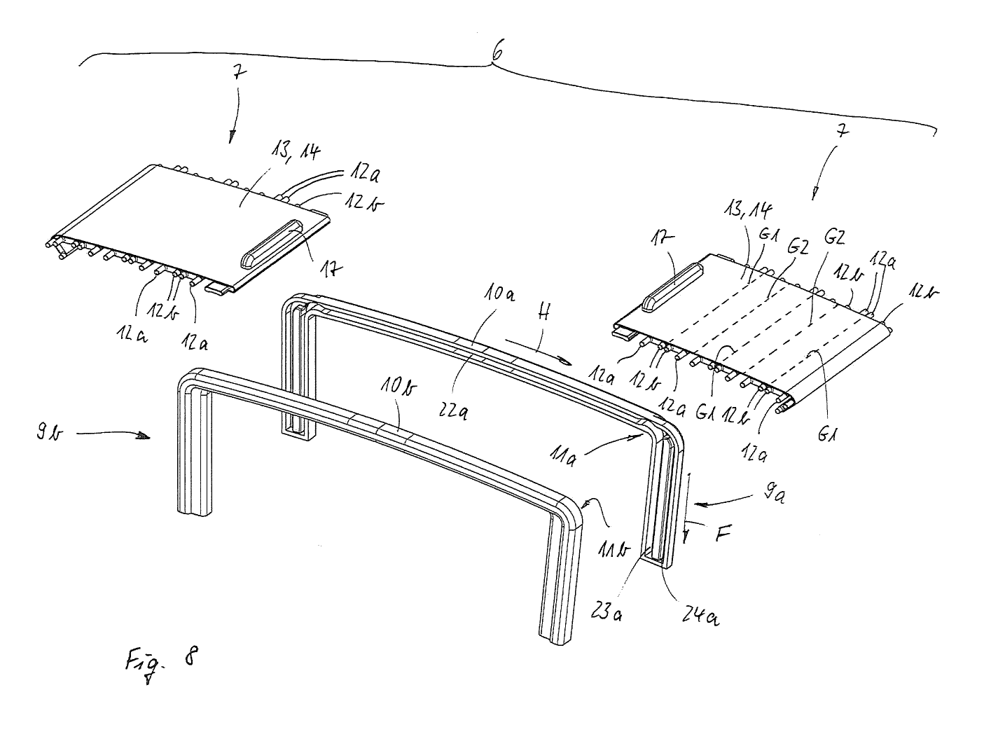

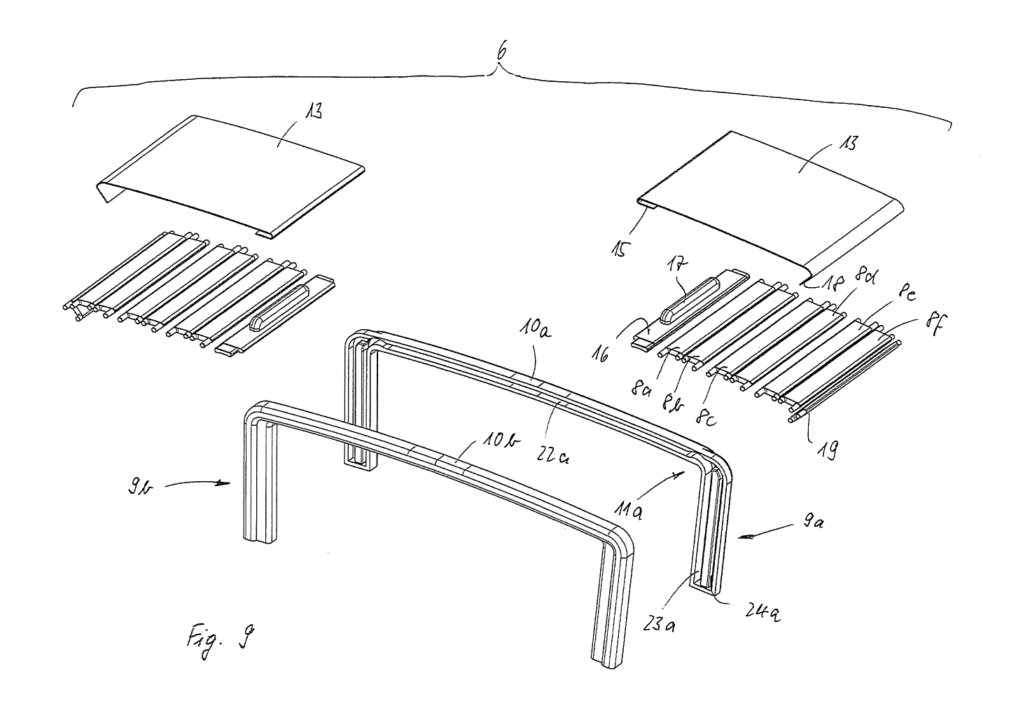

The covering device 6 comprises at least one foldable flat structure 7 which comprises a plurality of substantially dimensionally stable flat elements 8a to 8f which are connected together in an articulated manner and which, in particular, may be seen with reference to FIGS. 9 and 10. In the present case, the covering device 6 comprises two substantially identically foldable flat structures 7, which are arranged adjacent to one another relative to the transverse direction Y and which in each case are assigned to one of the receiver spaces 4. The flat structures 7 in the present case are configured symmetrically relative to a central transverse plane, not described in more detail, of the covering device 6 which is oriented parallel to an X-Z plane of the motor vehicle interior M. It is, however, not necessarily required that the covering device 6 comprises two flat structures 7 and/or that these flat structures are arranged adjacent to one another relative to the transverse direction Y. Rather, it is also possible that only one flat structure 7 or more than two flat structures 7 are provided. If more than one flat structure is provided, a plurality of flat structures may be arranged one behind the other, for example also relative to the longitudinal direction X. If the two foldable flat structures 7 have a construction which coincides in terms of structure and function, the components thereof and the portions thereof are provided with identical reference numerals. If hereinafter individual features are described in more detail only in connection with one of the foldable flat structures 7, the disclosure relevant thereto correspondingly applies to the other flat structure 7. Hereinafter, in order to avoid repetition, primarily the right-hand foldable flat structure 7 is described—relative to the drawing plane of FIGS. 6 to 11.

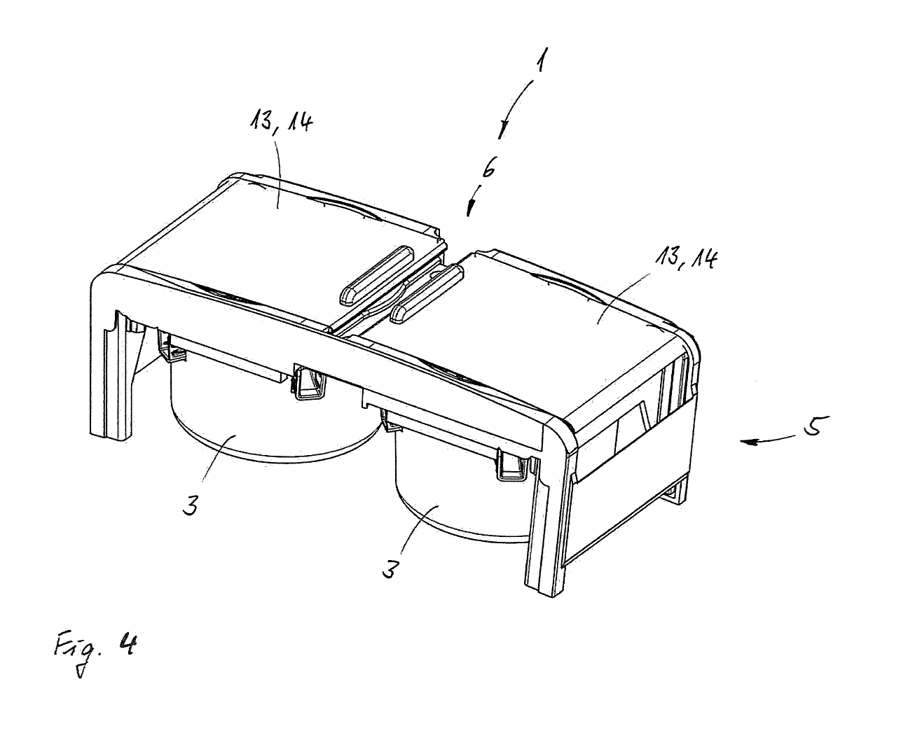

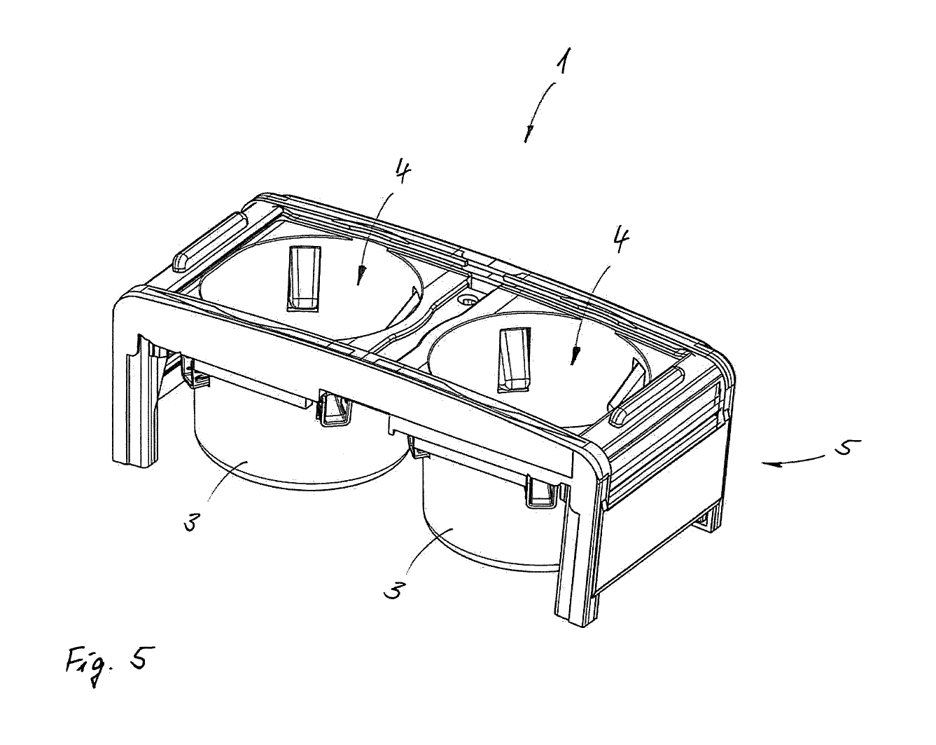

The covering device 6 further comprises at least one guide device 9a, the flat elements 8a to 8f being displaceably guided thereon in a manner described in more detail hereinafter. In the present case, a further guide device 9b which is arranged opposite the guide device 9a in the longitudinal direction X is provided. As is described hereinafter in more detail, although the two guide devices 9a, 9b are configured to be substantially identical to one another, they differ with regard to essential features of the invention which are described in more detail hereinafter at the relevant point. In the present case, the guide devices 9a, 9b in each case comprise a guide frame 10a and/or 10b. The guide frames 10a, 10b form in the present case respectively one component of the carrier frame 5 of the equipment unit 1 which, for example, may be seen with reference to FIGS. 4 and 5.

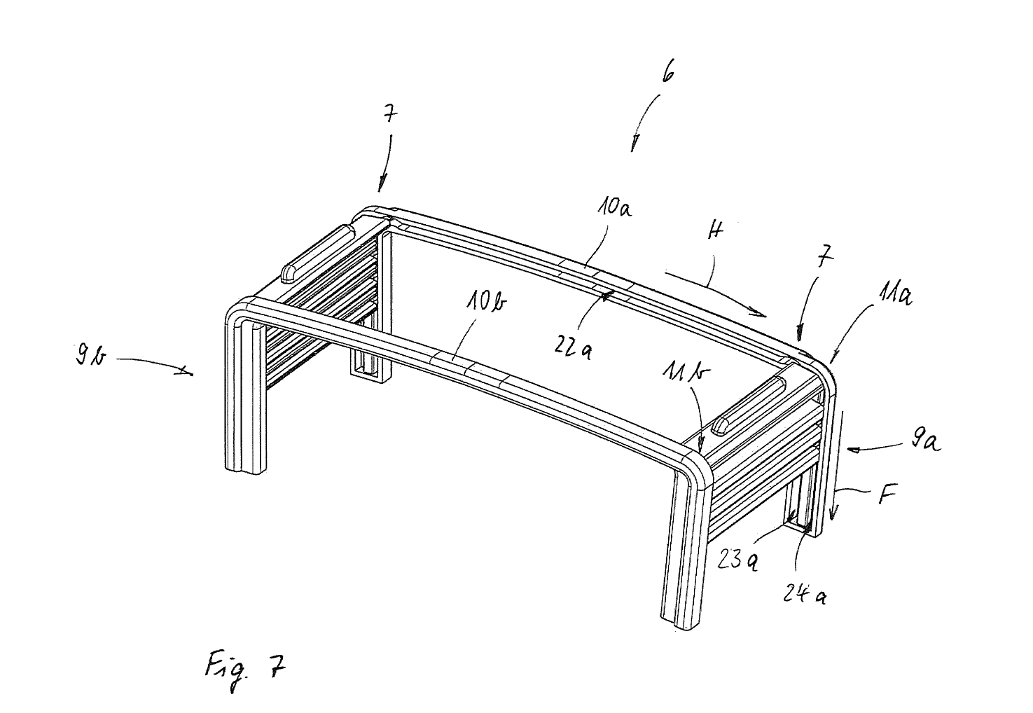

The dimensionally stable flat elements 8a to 8f are displaceably guided at opposing front end regions on the guide devices 9a, 9b, between a covered position in which the flat structure 7 at least partially covers the receiver space 4 (see for example FIGS. 4, 6) and an uncovered position in which the flat structure 7 at least partially uncovers the receiver space 4 (see for example FIGS. 5, 7). In the covered position the flat elements 8a to 8f are arranged adjacent to one another in the transverse direction Y and in a substantially planar manner in an upper region of the guide devices 9a, 9b, not described in more detail. Accordingly, in the uncovered position the flat elements 8a to 8f are arranged so as to be pivoted at an angle to one another in a lateral region of the guide devices 9a, 9b, wherein the flat structure 7 is folded in the manner of a concertina. In order to achieve such an arrangement of the flat elements 8a to 8f, and thus the flat structure 7, the at least one guide device 9a comprises at least one control region 11a on which different guide elements 12a, 12b of the flat elements 8a to 8f are path-controlled differently so that when displaced from the covered position into the uncovered position the flat elements 8a to 8f are arranged pivoted at an angle to one another and thus the flat structure 7 is folded in the manner of a concertina. Details of the control region 11a of the at least one guide device 9a and the embodiment of a control region 11b of the guide device 9b, made by way of reference thereto, and the embodiment of the different guide elements 12a, 12b and the path control thereof on the control regions 11a, 11b are described in more detail hereinafter at the corresponding point. Initially further features of the foldable flat structure 7 are described in detail.

As may be seen, in particular, in FIGS. 6 to 9, the foldable flat structure 7 comprises a flexible cover structure 13 which at least partially spans the flat elements 8a to 8f and which—in any case in the covered position of the flat structure 7—forms a visible surface 14 of the foldable flat structure 7. The cover structure 13 is configured in the present case in the form of a flexurally flexible material web produced from plastics material. Moreover, in the present case the cover structure 13 is connected by a material connection to the upper faces of the flat elements 8a to 8f. The cover structure 13 extends in the longitudinal direction X in each case substantially over the entire width of the flat elements 8a to 8f and relative to the transverse direction Y substantially over the entire length of the flat structure 7. At an internal front end region, relative to the transverse direction Y, the cover structure 13 comprises a fold 15. The fold 15 is folded at least partially about a front end region of an end element 16, which at one end forms a termination of the flat structure 7 and which is provided with an actuating element 17 for manual displacement of the flat structure 7 between the covered and uncovered positions. At a front end remote from the fold 15, the cover structure 13 comprises a folded edge 18 which is arranged on a holding element 19 of the flat structure 7. As may be seen, for example, with reference to FIG. 2, in the covered position substantially only the visible surface 14 of the covering device 6 on the equipment unit 1 may be seen so that, in particular, an attractive appearance and an improved impression of quality may be achieved. Additionally, the cover structure 13 prevents dirt particles or dust from entering the intermediate spaces, not described further, which are configured between the flat elements 8a to 8f, and thus from impairing the mobility thereof during the displacement.

In particular, it may be seen in FIG. 6 that in the covered position the flexible cover structure 13 is arranged to be substantially smooth-surfaced. In the uncovered position, as for example may be seen in FIG. 7, the flexible cover structure 13 is accordingly folded together with the flat structure 7 in the manner of a concertina.

It may be seen in FIG. 8 that the flexible cover structure 13 in each case forms an articulated connection G1, G2 between adjacently arranged flat elements 8a to 8f. The articulated connections G1, G2 are in each case indicated schematically with reference to FIG. 8 by means of dashed lines. The articulated connections G1, G2 in each case are formed in the manner of a film hinge, so that the articulated connection between adjacent flat elements, for example between the flat element 8a and the flat element 8b, is designed without additional mechanical articulated elements. Here, the imaginary axes of articulation of the articulated connections G1, G2 in the present case are respectively oriented parallel to the longitudinal direction X and thus parallel to a transverse direction of the flat structure.

For example it may be seen in FIG. 10 that directly adjacently arranged flat elements 8a, 8b and 8c, 8d as well as 8e, 8f in each case form a flat element pair 20a, 20b and/or 20c, wherein adjacent flat element pairs 20a and 20b and/or 20b and 20c in each case are arranged so as to form a fold gap 21b and/or 21c. The fold gaps 21b, 21c extend in the present case over the entire width of the flexible flat structure 7 and in the transverse direction Y have a gap dimension which approximately corresponds to half of the extent of a flat element 8a to 8f in the transverse direction Y. Accordingly, the flat elements 8a to 8f of one of the flat element pairs 20a to 20c in each case are arranged directly adjacent to one another and in this respect only form a contact gap.

As may be seen in FIG. 8 the flexible cover structure 13 forms an articulated connection of the first type G1 between the flat elements 8a to 8f of a flat element pair 20a to 20c and an articulated connection of the second type G2 between adjacent flat element pairs 20a to 20c in the region of the respective fold gap 21b and/or 21c. In the present case the articulated connections of the first type G1 and second type G2 differ relative to the maximum achievable joint angle. In any case, in the articulated connection G2 this is slightly larger than in the articulated connection G1 which results from the spaced-apart arrangement of the flat element pairs 12a to 12c forming the fold gaps 21b, 21c. As a result, in particular, the flat structure 7 may be folded in a particularly space-saving manner in the manner of a concertina in the uncovered position.

A further feature of the invention relates to the design of the guide devices 9a, 9b. As may be seen, for example, with reference to FIGS. 7 to 9, the guide device 9a comprises a main guide groove 22a which extends longitudinally in a main direction H. The main guide groove 22a branches in the control region 11a into a first fold guide groove 23a, the first guide elements 12a being assigned thereto, and into a second fold guide groove 24a, the second guide elements 12b being assigned thereto. In this case the fold guide grooves 23a, 24a extend longitudinally in a folding direction F which is angled relative to the main direction H. The main direction H extends in the present case in a slightly curved manner, substantially in the transverse direction Y. The folding direction F in the present case is angled by approximately 90° downwardly relative to the main direction H and in this regard extends substantially counter to a vertical direction Z of the motor vehicle interior. In this case, both the main guide groove 22a and the two fold guide grooves 23a, 24a are incorporated in the guide frame 10a. The guide frame 10a is correspondingly angled in an L-shaped manner—relative to the right-hand flat structure of the two flat structures 7. With regard to the guidance of the two foldable flat structures 7 on the guide device 9a, the guide frame 10a is angled in a U-shaped manner in this regard.

Proceeding from the covered position, as may be seen for example with reference to FIG. 10, the first and second guide elements 12a, 12b in each case are initially guided in the main guide groove 22a. When the flat structure 7 is displaced in the main direction H the flat elements 8a to 8f, starting with the flat element 8f, are guided via the control region 11a, wherein due to the design of the control region 11a, to be described in more detail, the first guide elements 12a are supplied to the first fold guide groove 23a and the second guide elements 12b are supplied to the second fold guide groove 24a. By this type of controlled path guidance of the guide elements 12a, 12b, the angled position of the flat elements 8a to 8f relative to one another is achieved, and thus the concertina-like folding of the flat structure 7 in the uncovered position (FIGS. 7, 11, 12). As a result of the angled design of the guide frame 10a, starting from a substantially planar orientation in the covered position, the flat structure 7 is downwardly guided on the control region 11a and folded, so that in the uncovered position the flat structure 7 is arranged to the side of the cylindrical receiver 3 (FIG. 5). The receiver space 4, therefore, may be opened at the top in an improved manner by the angled design of the guide device 9a. The same applies to the guidance of the flat elements 8a to 8f of the left-hand flat structure on the guide device 11a—relative to the drawing plane of FIGS. 6 to 11—so that in order to avoid repetition this is not specifically described in detail.

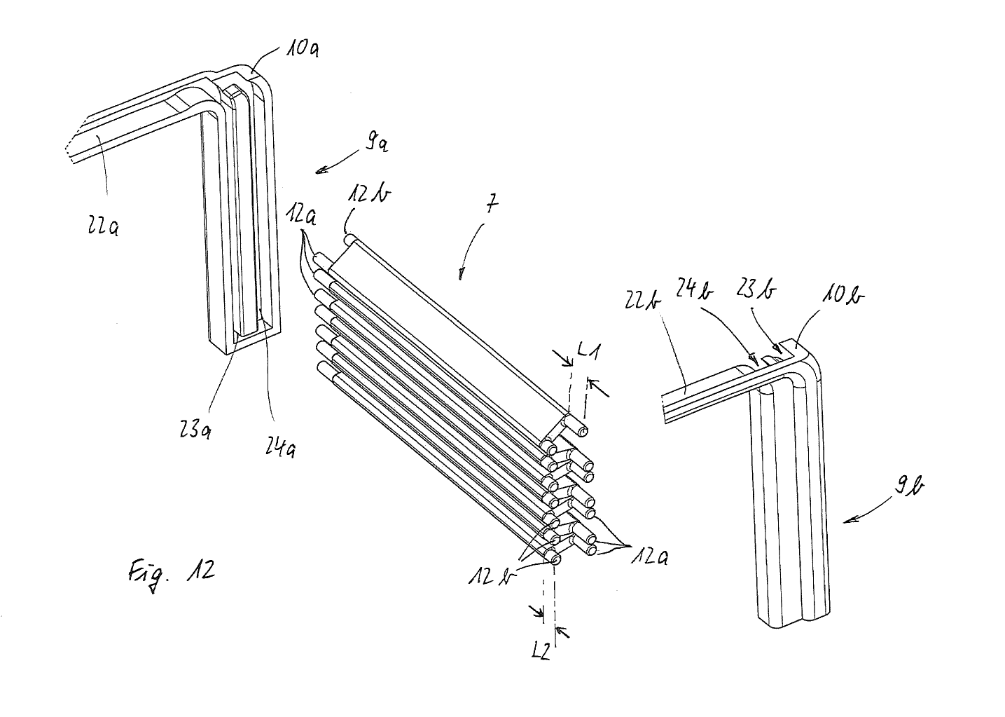

A further feature of the invention relates to the asymmetrical embodiment of the covering device 6, with regard to the path control. As may be seen, for example, with reference to FIG. 13, the guide elements 12a, 12b and the control region 11a of the first guide device 9a and the control region 11b of the second guide device 9b—relative to a central longitudinal plane P, which is indicated by dashed lines in FIG. 13—are arranged and/or designed asymmetrically. The asymmetrical arrangement of the guide elements 12a, 12b is explained in more detail hereinafter with reference to the flat elements 8a, 8b and/or the flat element pair 20a, and correspondingly applies to the further flat elements 8c to 8f and/or flat element pairs 20b, 20c. Relative to the central longitudinal plane P the guide elements 12a, 12b are arranged asymmetrically such that a second guide element 12b opposes a first guide element 12a in each case, and vice versa. In the transverse direction Y of the motor vehicle interior B, and in this regard in the longitudinal direction of the foldable flat structure 7, the guide elements 12a, 12b are arranged alternately in pairs. Thus the flat element pair 20a on an upper front end region—relative to the drawing plane of FIG. 13—from left to right initially comprises a first guide element 12a which is followed by two adjacently arranged second guide elements 12b, which in turn are followed by a first guide element 12a. On a lower front end region the flat element pair 20a, in turn from left to right, initially comprises a second guide element 12b which is followed by two first guide elements 12a, which in turn are followed by a second guide element 12b. The first and second guide elements 12a, 12b in the present case are respectively configured in the form of circular cylindrical guide pins which differ in terms of their axial length. In this regard, in the present case an axial length L1 of the first guide elements 12a is greater than an axial length L2 of the second guide elements 12b.

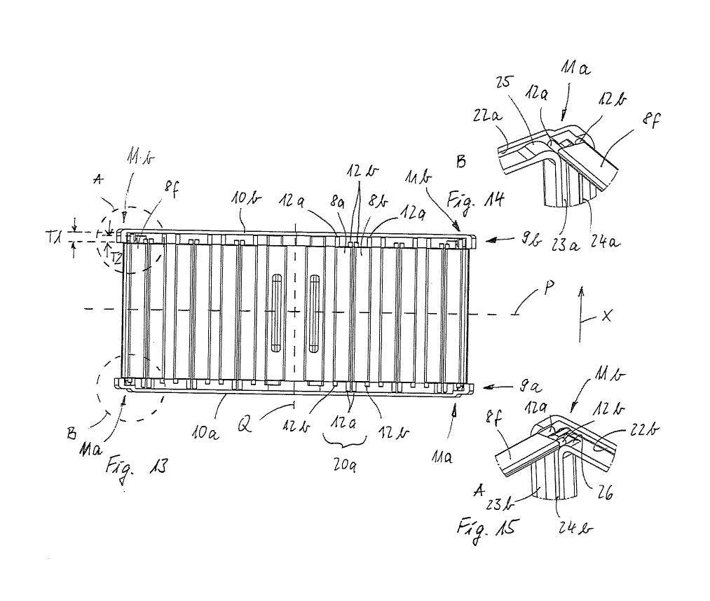

The asymmetrical design of the control regions 11a, and 11b may be seen, in particular, with reference to FIGS. 13 to 15. In this case, the detailed views of FIGS. 14 and 15 refer in each case to the left-hand control regions 11a and 11b of the first guide device 9a—relative to the drawing plane of FIG. 13—and/or the second guide device 9b. The right-hand control regions 11a and 11b are in the present case symmetrically designed relative to a central transverse plane Q, relative to the respective left-hand control region, so that hereinafter in order to avoid repetition details are provided only about the left-hand control region 11a, 11b. Both guide devices 9a, 9b in each case comprise a main guide groove 22a, 22b which in the region of the respective control region 11a, 11b branches into a first fold guide groove 23a, 23b and into a second fold guide groove 24a, 24b. In each case, the first guide elements 12a of the flat elements 8a to 8f are assigned to the first fold guide grooves 23a, 23b. In each case, the second guide elements 12b of the flat element 8a to 8f are assigned to the second fold guide grooves 24a, 24b. With reference to FIGS. 13 to 15 it may be seen that the control regions 11a, 11b, in particular the geometric design of the branching of the main guide grooves 22a, 22b into the first fold guide grooves 23a, 23b and the second fold guide grooves 24a, 24b, are designed differently such that similar guide elements 12a, 12b of a flat element 8a to 8f are path-controlled differently at the control regions 11a, 11b. The asymmetrical design of the control regions 11a, 11b is described in detail hereinafter. Thus it may be seen with reference to FIG. 14 that in the guide device 9a the main guide groove 22a initially branches into the first fold guide groove 23a and then branches into the second fold guide groove 24a. Accordingly, in the guide device 9b the main guide groove 22b initially branches into the second fold guide groove 24b and then into the first fold guide groove 23b. For the purposes of the variable path control of similar guide elements 12a, 12b, the control regions 11a, 11b have control elements 25, 26 which are different from one another. The control region 11a has a first control element 25 which in the present case is designed in the form of a ramp. The control region 11b has a second control element 26 which in the present case is designed in the form of an indentation. The ramp adjoins a front end region of the main guide groove 22a facing the control region 11a. By means of the ramp 25, during a displacement of the flat structure 7 from the covered position into the uncovered position, the second guide elements 12b are guided beyond the first fold guide groove 23a. The indentation 26 adjoins a front end region of the main guide groove 22b facing the control region 11b. By means of the indentation 26, the second guide elements 12b are conducted to the second fold guide groove 24b. As a result, the paths of the first guide elements 12a are guided differently at the control region 11a in comparison with the first guide elements 12a at the control region 11b. The same applies with regard to the different path guidance of the second guide elements 12b.

As may be seen further from FIGS. 13 to 15, the first fold guide grooves 23a, 23b have a groove depth T1. The second fold guide grooves 24a, 24b have a groove depth T2. Corresponding to the axial length L1 of the first guide elements 12a assigned to the first fold guide grooves 23a, 23b, the groove depth T1 in the present case is greater than the groove depth T2. In this manner, in particular, during the path control the first fold guide elements 12a are prevented from inadvertently passing into the second fold guide grooves. This may be seen with reference to FIGS. 14 and 15.

1. Covering device for a motor vehicle having at least one foldable flat structure which comprises a plurality of substantially dimensionally stable flat elements which are connected together in an articulated manner and which are displaceably guided on at least one guide device between a covered position in which the flat structure at least partially covers a receiver space and an uncovered position in which the flat structure at least partially uncovers the receiver space, wherein the at least one guide device comprises at least one control region, different guide elements of the flat elements being path-controlled differently thereon, such that in the uncovered position the flat elements are pivoted at an angle to one another and the flat structure is folded in the manner of a concertina, wherein a flexible covering structure is provided, said flexible covering structure at least partially spanning the flat elements and forming a visible surface of the foldable flat structure.

2. Covering device according to claim 1, wherein in the covered position the flexible covering structure is substantially smooth-surfaced and in the uncovered position the flexible covering structure is folded together with the flat structure in the manner of a concertina.

3. Covering device according to claim 1, wherein the flexible covering structure forms in each case an articulated connection in the manner of a film hinge between adjacently arranged flat elements.

4. Covering device according to claim 1, wherein flat elements which are arranged immediately adjacent to one another in each case form a flat element pair, wherein adjacent flat element pairs are arranged so as to form in each case a fold gap.

5. Covering device according to claim 4, wherein the flexible covering structure forms an articulated connection of a first type between the flat elements of a flat element pair and/or forms an articulated connection of a second type between adjacent flat element pairs in the region of the respective fold gap.

6. Covering device according to claim 1, wherein the guide device comprises a main guide groove which extends longitudinally in a main direction and which in the control region branches into a first fold guide groove, to which the first guide elements are assigned, and into a second fold guide groove, to which the second guide elements are assigned, wherein the fold guide grooves extend longitudinally in a folding direction which is angled relative to the main direction.

7. Covering device according to claim 6, wherein the main direction and the folding direction are angled relative to one another by more than 45°, preferably by approximately 90°.

8. Covering device according to claim 6, wherein the guide device comprises an angled, preferably L-shaped and/or U-shaped, guide frame, the main guide groove and the first fold guide groove and the second fold guide groove being incorporated therein.

9. Covering device according to claim 1, wherein two guide devices which are arranged opposite one another in the transverse direction are provided, the flat elements being displaceably guided thereon in each case by first guide elements and second guide elements, wherein the guide elements and the control regions are arranged and/or designed asymmetrically—relative to a central longitudinal plane—such that similar guide elements of a flat element are path-controlled differently at the control regions.

10. Covering device according to claim 9, wherein the guide devices in each case comprise a main guide groove which in the region of the respective control region branches into a first fold guide groove, to which the first guide elements are assigned, and into a second fold guide groove, to which the second guide elements are assigned.

11. Covering device according to claim 9, wherein an axial length of the first guide elements is greater than an axial length of the second guide elements and/or in that a groove depth of the first fold guide grooves is greater than a groove depth of the second fold guide grooves.

12. Covering device according to claim 10, wherein in a first of the guide devices the main guide groove initially branches into the first fold guide groove and subsequently into the second fold guide groove, and in that in a second of the guide devices the main guide groove initially branches into the second fold guide groove and subsequently into the first fold guide groove.

13. Covering device according to claim 10, wherein the control region of a first of the guide devices comprises a first control element in the form of a ramp which adjoins a front end region of the main guide groove, the second guide elements being conducted thereby beyond the first fold guide groove.

14. Covering device according to claim 10, wherein the control region of a second of the guide devices comprises a second control element in the form of an indentation which adjoins a front end region of the main guide groove, the second guide elements being conducted thereby to the second fold guide groove.

15. Equipment unit, in particular a drink holder, for a motor vehicle interior having at least one receiver space for receiving an object, in particular a drink receptacle, and having a covering device which is assigned to the receiver space, the covering device having at least one foldable flat structure which comprises a plurality of substantially dimensionally stable flat elements which are connected together in an articulated manner and which are displaceably guided on at least one guide device between a covered position in which the flat structure at least partially covers a receiver space and an uncovered position in which the flat structure at least partially uncovers the receiver space, wherein the at least one guide device comprises at least one control region, different guide elements of the flat elements being path-controlled differently thereon, such that in the uncovered position the flat elements are pivoted at an angle to one another and the flat structure is folded in the manner of a concertina, wherein a flexible covering structure is provided, said flexible covering structure at least partially spanning the flat elements and forming a visible surface of the foldable flat structure.

16. Equipment unit according to claim 15, wherein two receiver spaces are provided, in each case a foldable flat structure being assigned thereto, wherein the receiver spaces and the foldable flat structures are arranged symmetrically such that the flat structures are displaceable in opposing directions, in particular parallel to a transverse direction of the motor vehicle interior, between the covered position and the uncovered position.

17. Covering device for a motor vehicle having at least one foldable flat structure which comprises a plurality of substantially dimensionally stable flat elements which are connected together in an articulated manner and which are displaceably guided on at least one guide device between a covered position in which the flat structure at least partially covers a receiver space and an uncovered position in which the flat structure at least partially uncovers the receiver space, wherein the at least one guide device comprises at least one control region, different guide elements of the flat elements being path-controlled differently thereon, such that in the uncovered position the flat elements are pivoted at an angle to one another and the flat structure is folded in the manner of a concertina, wherein the guide device comprises a main guide groove which extends longitudinally in a main direction and which in the control region branches into a first fold guide groove, to which the first guide elements are assigned, and into a second fold guide groove, to which the second guide elements are assigned, wherein the fold guide grooves extend longitudinally in a folding direction which is angled relative to the main direction.

18. Covering device for a motor vehicle having at least one foldable flat structure which comprises a plurality of substantially dimensionally stable flat elements which are connected together in an articulated manner and which are displaceably guided on at least one guide device between a covered position in which the flat structure at least partially covers a receiver space and an uncovered position in which the flat structure at least partially uncovers the receiver space, wherein the at least one guide device comprises at least one control region, different guide elements of the flat elements being path-controlled differently thereon, such that in the uncovered position the flat elements are pivoted at an angle to one another and the flat structure is folded in the manner of a concertina, wherein two guide devices which are arranged opposite one another in the transverse direction are provided, the flat elements being displaceably guided thereon in each case by means of first guide elements and second guide elements, wherein the guide elements and the control regions are arranged and/or designed asymmetrically—relative to a central longitudinal plane—such that similar guide elements of a flat element are path-controlled differently at the control regions.
